(19) United States
(12) Patent Application Publication
(10) Pub. No.: US 2011/0012490 A1
(43) Pub. Date: Jan. 20, 2011

(54) STORAGE SYSTEM AND METHOD HAVING A SELECTIVELY RECONFIGURABLE SELF-STORAGE UNIT AND FOLD-UP STORAGE APPARATUS FOR USE THEREWITH

(75) Inventor: Ronald M. Schwendemann, Olathe, KS (US)

Correspondence Address: Hovey Williams LLP, 10801 Mastin Blvd., Suite 1000, Overland Park, KS, 66210, US

(73) Assignee: RACKAWAY SYSTEMS LLC, Overland Park, KS (US)

(21) Appl. No.: 12/836,450

(22) Filed: Jul. 14, 2010

Related U.S. Application Data
(60) Provisional application No. 61/226,130, filed on Jul. 16, 2009.

(51) Int. Cl. A47B 81/00; A47B 96/02; A47B 91/00; E05B 67/00; G06Q 90/00

(52) U.S. Cl. 312/326; 211/149; 70/20; 705/400

(57) ABSTRACT

A storage system and method provides a storage apparatus which is particularly suitable for use in an enclosed in a self-storage unit to be rented. The storage apparatus includes a plurality of shelves that are selectively movable to and from an in-use position in which the plurality of shelves are arranged in a horizontal configuration to receive items thereon, and a non-use position in which the plurality of shelves are arranged in a low-profile vertical configuration to consume minimal space in the storage unit. The storage apparatus further includes a locking mechanism to enable locking of the plurality of shelves in the non-use position to prevent use thereof when the storage apparatus has not been rented.

### RELATED APPLICATION

This application claims the priority benefit of U.S. Provisional Application Ser. No. 61/226,130, filed Jul. 16, 2009, titled SELECTIVELY RECONFIGURABLE SELF-STORAGE UNIT AND FOLD-UP STORAGE RACK FOR USE THEREWITH, which is hereby incorporated in its entirety by reference herein.

### BACKGROUND

1. Field

The present inventive concept relates generally to storage systems. More specifically, embodiments of the present inventive concept concern a shelving storage apparatus that is selectively reconfigurable into a variety of orientations, with the apparatus being particularly suitable for use with a storage system and method.

2. Discussion of Prior Art

As residential and commercial real estate costs continue to increase, demand for offsite storage, such as self-storage units offered for rent by storage facilities, also increases. In fact, the self-storage industry has been one of the fastest growing sectors of the United States commercial real estate industry over the past thirty-five years. Nearly one in ten U.S. households currently rents a storage unit.

Storage units are enclosed spaces to provide a housing with security for a user's items. Conventional storage units have a ceiling, floor, and four walls with a locking door, such as a roll-up overhead door, in one of the four walls to provide access thereto. Conventional storage unit have various sizes ranging from closet sized to garage sized, for example, from five-by-five feet to twenty-by-thirty feet with a height of eight feet.

Rent amount for storage units is commonly calculated by size, that is, per square foot. Consequently, it is desirable to select as small of a storage unit as possible that is capable of accommodating all items intended to be stored by a user.

Conventional storage facilities simply rent a storage unit without any features other than the ceiling, floor, and four walls with the locking door. Thus, if an item to be stored in a conventional storage unit does not consume all space between the ceiling and floor, the user may resort to stacking one or more items on the item, if possible, to maximize the height of the storage unit.

Some items, however, particularly those that are not boxed or reside in boxes of low bursting or crush strength, are unable to be stacked. Additionally, as items are stacked on top of each other and weight increases, the likelihood of crushing items toward a bottom of the stack increases.

Additionally, the four walls of conventional storage units are not load bearing. Thus, affixing shelves or other like structure to the four walls is not a viable option.

Additionally, there are typically a number of commercial storage facilities offering self-storage units for rent in any one area that compete with each other for business. Thus, it is desirable for a storage facility to provide incentives to entice users who desire use of a storage unit to use its storage facility thereby obtaining a competitive edge over other storage facilities and providing an additional source of potential revenue.

There are also applications outside the rental storage industry in which improved shelving units are desired. For example, in office or commercial (or even home, such as apartment) use, space may be at a premium.

### SUMMARY

The following brief summary is provided to indicate the nature of the subject matter disclosed herein. While certain aspects of the present inventive concept are described below, the summary is not intended to limit the scope of the present inventive concept.

Embodiments of the present inventive concept provide a storage system and method that does not suffer from the problems and limitations of conventional storage systems, such as those set forth above, and provides enticement to users of commercial storage facilities.

The present inventive concept broadly concerns an inventive fold-up storage rack designed to minimize the space it occupies when not in use.

Another aspect of the present invention concerns a storage system and method having a storage apparatus that is selectively configurable and lockable in a storage unit between a use configuration and a non-use configuration.

The present inventive concept provides a storage system and method having additional functionality for a storage unit relative to traditional storage systems such that use of the present inventive concept creates a potential source of additional revenue for a commercial storage facility that leases the storage unit.

More specifically, according to one aspect of the present invention, a fold-up storage rack is provided, the fold-up storage rack including stationary support structure, shelving having a first hinged connection with the stationary support structure for selective placement of the shelving in either a deployed position in which the shelving is folded-down and extends generally horizontally outwardly away from the stationary support structure or a stowed position in which the shelving is folded-up and extends generally vertically upwardly adjacent the stationary support structure, and movable support structure having a second hinged connection with the shelving at a location spaced outwardly from the first hinged connection for engaging a supporting surface below the shelving when the shelving is in the deployed position and supporting the shelving above such surface, the movable support structure being disposed to pivot relative to the shelving as the shelving is raised into the stowed position whereby to be disposed adjacent the stationary support structure when the shelving is in the stowed position. According to another aspect of the present invention, a selectively reconfigurable storage unit is provided, the storage unit including an enclosure having a floor and a plurality of walls projecting upwardly from the floor to cooperatively define a confined storage space within which a person can move, the enclosure further having an access door permitting access to the storage space from outside the enclosure when the door is open, and at least one fold-up storage rack within the storage space adjacent a wall of the enclosure for supporting articles off the floor of the enclosure, the storage rack being selectively shiftable between a deployed position in which shelving of the rack projects generally horizontally outwardly away from the wall to occupy a portion of the storage space and a stowed position in which the shelving is collapsed generally flatly against the wall to avoid occupying the portion of the storage space. According to another aspect of the present invention, a method for renting a storage unit is provided, the method including providing a storage unit operable to secure items to be stored therein; providing at least one storage apparatus secured within the storage unit, the storage apparatus having a use configuration and a non-use configuration; locking the storage apparatus in the non-use configuration to prevent conversion of the storage apparatus from the non-use configuration to the use configuration; offering to rent the storage unit for a first amount; offering to rent the storage apparatus for a second amount; and unlocking the storage apparatus to permit conversion of the storage apparatus from the non-use configuration to the use configuration if the first amount and the second amount are received by an operator of the storage unit. According to an aspect of the present inventive concept, a storage apparatus is provided in an enclosed storage unit and includes a plurality of shelves that are dimensioned and configured to receive items thereon. The plurality of shelves are selectively movable to and from an in-use position that provides the plurality of shelves in a horizontal configuration to receive items thereon, and a non-use position that provides the plurality of shelves in a low-profile vertical configuration to consume minimal space in the storage unit. Additional aspects, advantages, and utilities of the present inventive concept will be set forth in part in the description which follows and, in part, will be obvious from the description, or may be learned by practice of the general inventive concept.

### BRIEF DESCRIPTION OF THE DRAWING FIGURES

Preferred embodiments of the present inventive concept are described in detail below with reference to the attached drawing figures, wherein:

FIG. 1 is a front elevated view of a storage unit, in accordance with an exemplary embodiment of the present inventive concept, illustrating a plurality of storage apparatuses in an in-use configuration;

FIG. 2 is a front elevated view of the storage unit illustrated in FIG. 1, illustrating the plurality of storage apparatuses in a stowed configuration;

FIG. 3 is a front left-side perspective view of the storage apparatus illustrated in FIG. 1, illustrating one of the storage apparatuses in the in-use configuration;

FIG. 4 is an enlarged front left-side perspective view of the storage apparatus illustrated in FIG. 1, illustrating one of the storage apparatuses in the use configuration;

FIG. 5 is an enlarged cross-sectional view taken along line 5-5 of FIG. 4 of one of the storage apparatuses, illustrating an inner hinge;

FIG. 6 is an enlarged cross-sectional view taken along 6-6 of FIG. 4 of one of the storage apparatuses, illustrating an outer hinge;

FIG. 7 is an enlarged front left-side perspective view of the storage apparatus illustrated in FIG. 1, illustrating one of the storage apparatuses in the use configuration.

FIG. 8 is an enlarged front left-side perspective view of the storage apparatus illustrated in FIG. 1, illustrating one of the storage apparatuses in the stowed configuration; and

FIG. 9 is an enlarged front perspective view of the storage apparatus illustrated in FIG. 1, illustrating one of the storage apparatuses in the stowed configuration.

The drawing figures do not limit the present inventive concept to the specific embodiments disclosed and described herein. The drawings are not necessarily to scale, emphasis instead being placed upon clearly illustrating the principles of the preferred embodiment.

### DETAILED DESCRIPTION OF THE EXEMPLARY EMBODIMENT

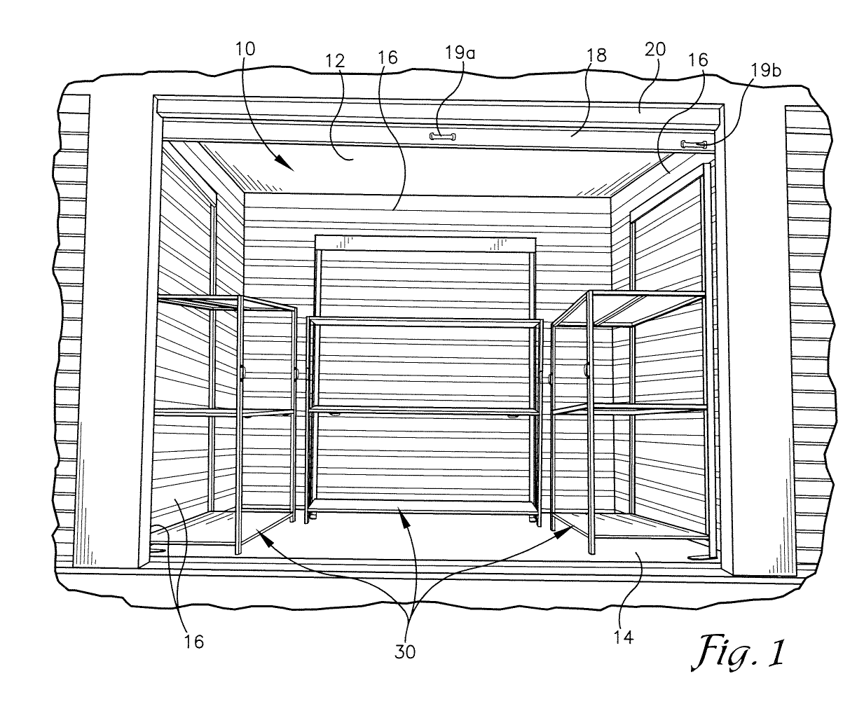

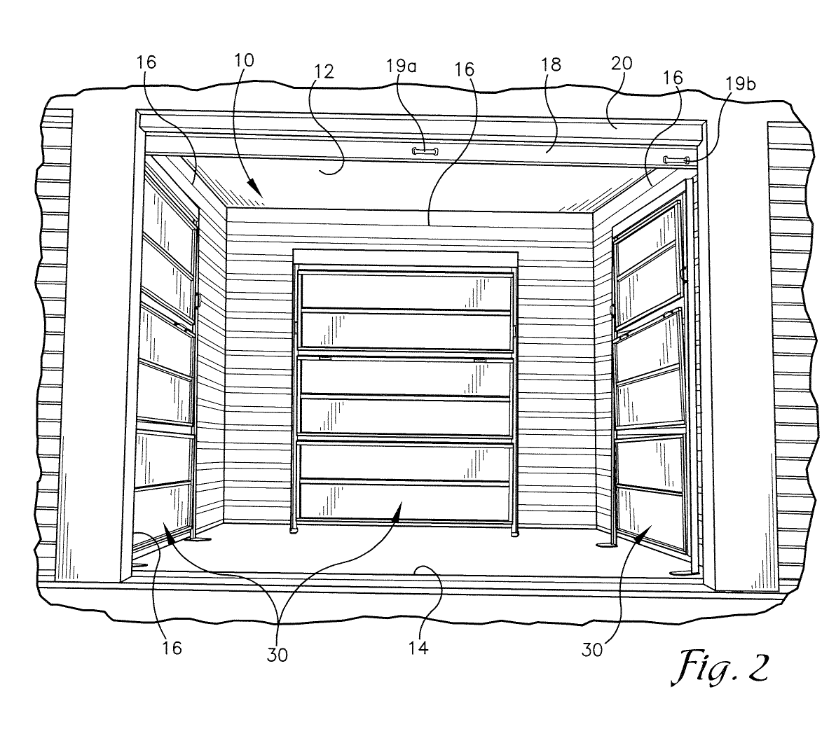

Turning to FIGS. 1 and 2, a storage unit 10 is illustrated in an exemplary embodiment in the form of an enclosed space having a ceiling 12, floor 14, and four walls 16 with a locking roll-up door 18 in one of the four walls 16 to provide access thereto. The roll-up door 18 has a plurality of handles 19a and 19b to facilitate opening and closing of the door 18. When the door 18 is open, the door 18 is rolled into and substantially housed in an overhead compartment 20.

The storage unit 10 includes three storage apparatuses 30 permanently mounted therein, as illustrated in FIGS. 1 and 2. It is foreseen, however, that the storage unit 10 may have any number of storage apparatuses 30.

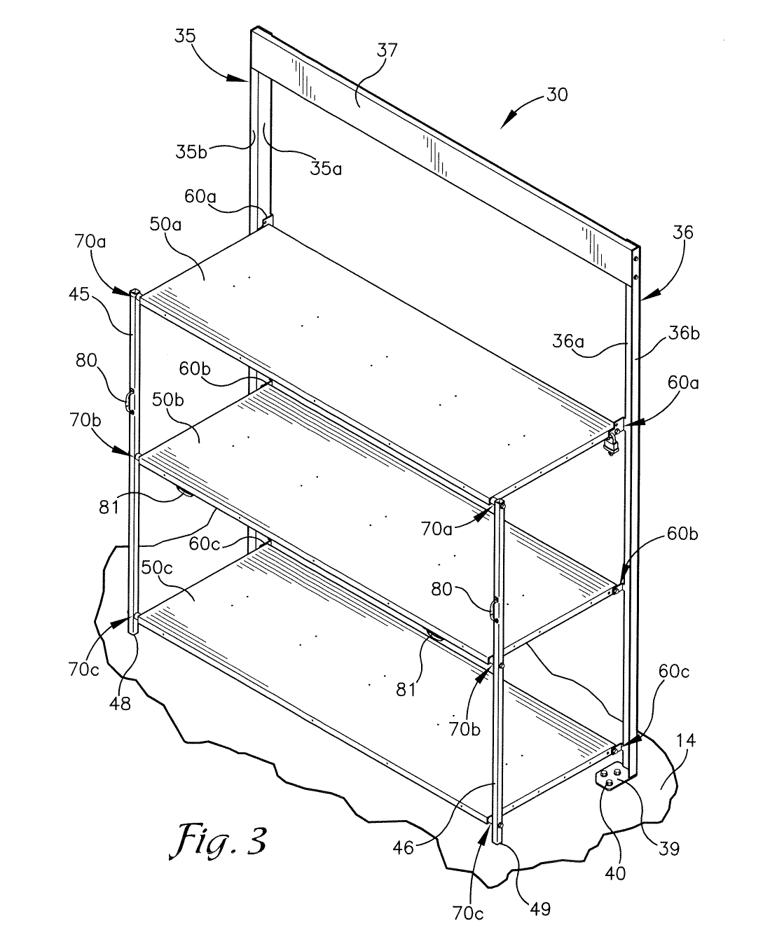

Turning to FIGS. 3, 4 and 5, each storage apparatus 30 includes a pair of laterally-spaced, stationary support legs 35 and 36 having a lateral connector element 37 therebetween and connected to a top end of the legs 35 and 36. In addition to providing stability to the storage apparatus 30, it is foreseen that the lateral connector element may be used as a display for signage, advertising, usage instructions, safety warnings, and/or the like.

Each of the stationary legs 35 and 36 are L-shaped in transverse cross-section and include rear abutment surfaces 35a and 36a that extend toward each other and projecting side surfaces 35b and 36b that extend parallel to each other. Additionally, the stationary legs 35 and 36 respectively include bases 38 and 39 on a bottom end of the stationary legs 35 and 36 opposite to the lateral connector element 37. The bases 38 and 39 have a sufficient footprint to provide structural integrity to the storage apparatus 30 without any additional structural support. The bases 38 and 39 secure the storage apparatus 30 to the floor 14 of the storage unit 10 and maintain the stationary legs 35 and 36 in a vertical position. In this manner, the storage apparatus 30 is only connected to the floor 14, which is preferably concrete, and maintains its position and functionality in the storage unit 10 without any additional connections or support means.

In the exemplary embodiment, the bases 38 and 39 are permanently mounted to the floor 14 of the storage unit 10 via ⅜″ concrete bolts 40 extending through each of the bases 38 and 39. It is foreseen, however, that the stationary legs 35 and 36 may be secured to the floor 14 via any suitable fastener. Additionally, it is foreseen that the storage apparatus 30, particularly the rear abutment surfaces 35a and 36a of the stationary legs 35 and 36 and/or the lateral connector element 37, may be secured to one or more of the walls 16 of the storage unit in addition to or instead of being secured to the floor 14. Additionally, it is foreseen that the storage apparatus 30 could be entirely supported by one or more of the walls 16 via wall mounts (not illustrated) with the bottom end of the stationary legs 35 and 36 omitted.

The legs 35 and 36, connector element 37, bases 38 and 39, and connectors 40 cooperatively form stationary support structure for each apparatus 30. This stationary support structure may be alternatively configured without departing from the scope of the present invention. For example, the structure need not be secured to the floor (e.g., if the wall is capable of sufficiently supporting the apparatus 30 and the contents stored thereon). Furthermore, the legs 35 and 36 may alternatively be secured to one of the walls 16 without the use of the connector element 37.

Each storage unit further includes a pair of laterally-spaced, movable support legs 45 and 46 that run parallel to the stationary legs 35 and 36. The moveable legs 45 and 46 each have a bottom end 48 and 49, respectively, to abut the floor 14 of the storage unit 10.

The moveable support legs 45 and 46 form movable support structure for the shelving of each apparatus 30. The moveable support structure maybe varied in design without departing from the scope of the present invention. For example, the moveable support structure may alternatively compare a single leg positioned centrally between the end of the shelves.

The moveable legs 45 and 46 are connected to the stationary legs 35 and 36 via a plurality of horizontal shelves 50a, 50b, and 50c positioned therebetween. The plurality of shelves 50a, 50b, and 50c include an upper shelf 50a, a middle shelf 50b, and a lower shelf 50c, and are each sized and shaped to receive and store items thereon. While the exemplary embodiment includes three generally rectangular shelves 50a, 50b, and 50c of two to three feet in width by four, six, or eight feet in length, it is foreseen that the storage apparatus 30 may have any number of shelves of any size and shape.

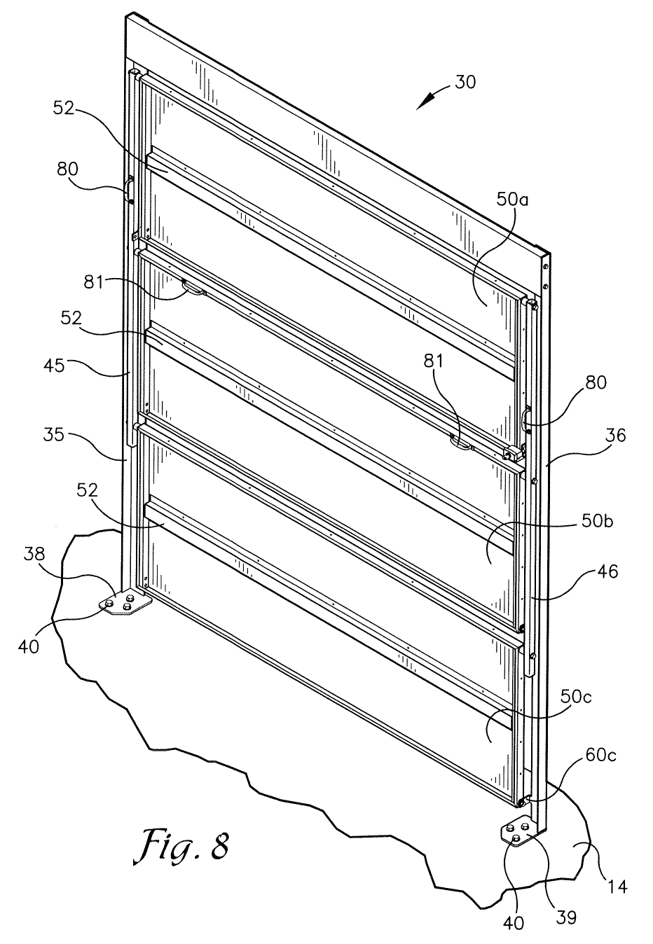

Each of the shelves 50a, 50b, and 50c have a support 52 extending horizontally along a length thereof, as illustrated in FIG. 8, to provide the shelves 50a, 50b, and 50c with an increased maximum load capacity of items stored thereon. In the exemplary embodiment, the shelves 50a, 50b, and 50c have a maximum load capacity of three hundred pounds when sized at two feet by six feet. It is foreseen, however, that the maximum load capacity can be altered by providing additional support elements and/or altering sizes and/or shapes of the shelves 50a, 50b, and 50c.

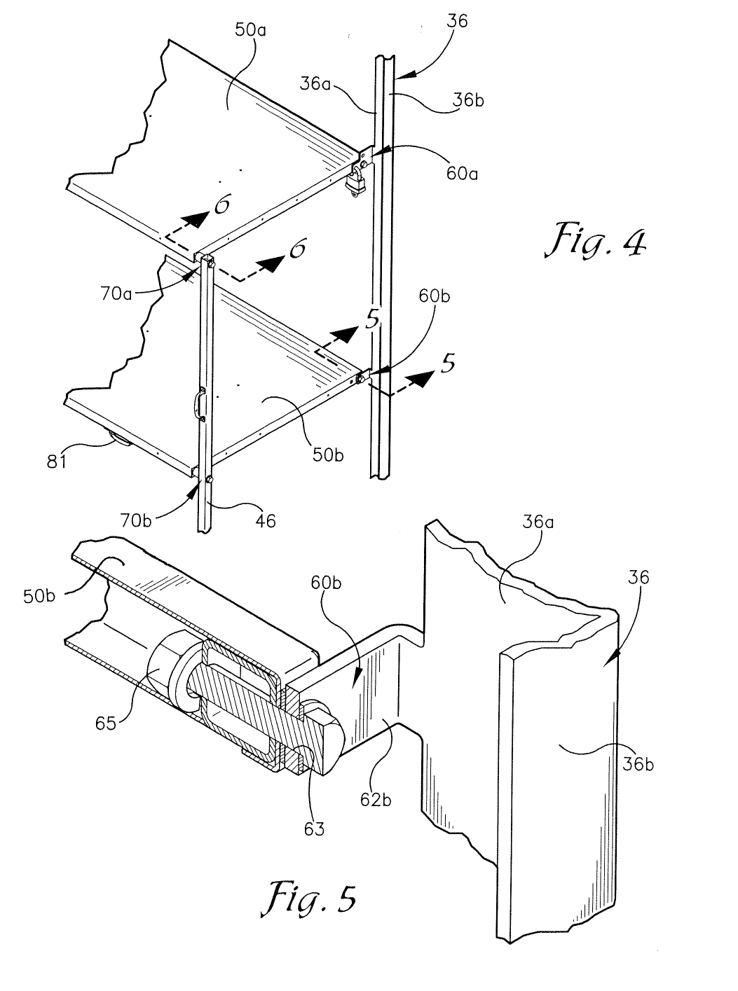

The stationary legs 35 and 36 each have a plurality of inner hinge assemblies 60a, 60b, and 60c spaced along a length of the stationary legs 35 and 36, as illustrated in FIGS. 3 and 4. Each inner hinge assembly 60a, 60b, and 60c respectively includes a tab 62a, 62b, 62c extending perpendicular from the stationary legs 35 and 36 with at least one aperture therethrough, such as aperture 63 of inner hinge assembly 60b, as illustrated in FIG. 5. Each of the apertures, including aperture 63, are sized and shaped to receive a bolt, such as bolt 65, therethrough to pivotally fasten the three shelves 50a, 50b, and 50c to the stationary legs 35 and 36.

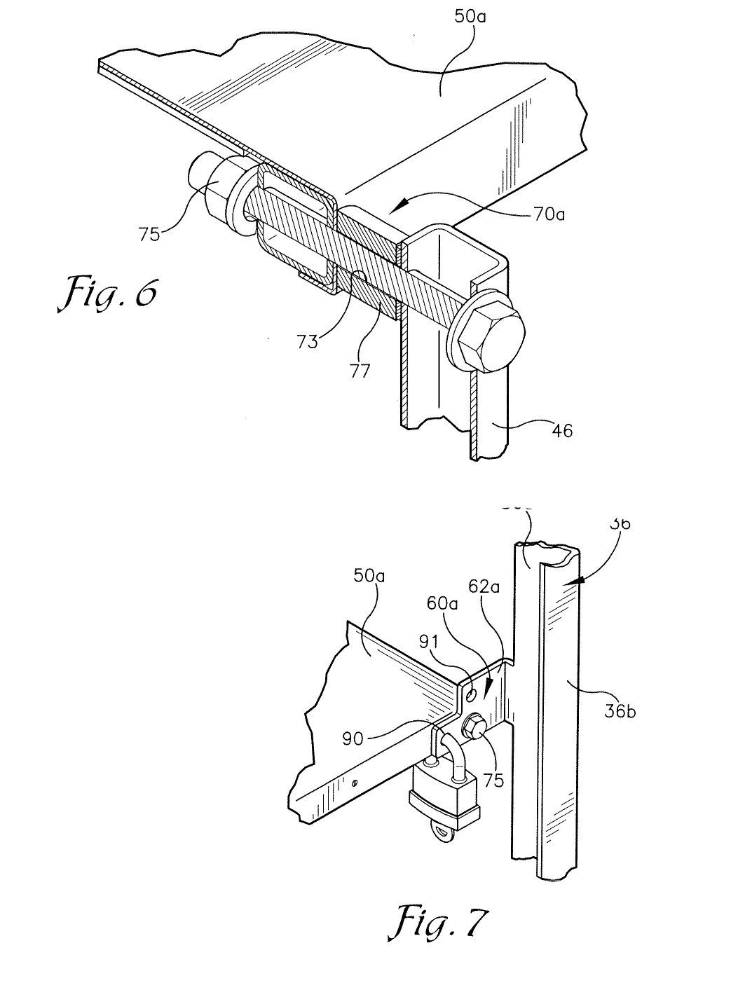

The moveable legs 45 and 46 each have a plurality of outer hinge assemblies 70a, 70b, and 70c spaced along a length of the legs 45 and 46, as illustrated in FIGS. 3 and 4. Each outer hinge assembly 70a, 70b, and 70c respectively includes an aperture therethrough, such as aperture 73 of hinge assembly 70a, as illustrated in FIG. 6. Each of the apertures, including aperture 73, are sized and shaped to receive a bolt, such as bolt 75, therethrough to pivotally fasten the three shelves 50a, 50b, and 50c to the moveable legs 45 and 46. Each of the outer hinge assemblies 70a, 70b, and 70c also include a spacer, such as spacer 77, to advantageously space the moveable legs 45 and 46 from the shelves 50a, 50b, and 50c and reduce friction therebetween.

Those of ordinary skill in the art will appreciate that the construction of hinge assemblies 60a, 60b, 60c, 70a, 70b, and 70c may be varied in any suitable masses without deporting from the spirit of the present invention. It is only important with respect to the illustrated embodiment to have a swingable or hinged connection between the shelves 50a, 50b, and 50c and the stationary and moveable support structure. Any suitable connection is within the ambit of the present invention.

The inner hinge assemblies 60a, 60b, and 60c cooperate with the outer hinge assemblies 70a, 70b, and 70c to enable movement of the storage apparatus 30 as a single unit to and from a use configuration, as illustrated in FIGS. 1 and 3, and a stowed configuration, as illustrated in FIGS. 2 and 8. When the storage apparatus 30 is in the use configuration, the bottom end 48 and 49 of the moveable legs 45 and 46 each abuts the floor 14 and shelves 50a, 50b, and 50c are horizontal to receive and store items thereon. When the storage apparatus 30 is in the stowed configuration, the moveable legs 45 and 46, positioned at least in part by the spacer 77, nest within the stationary legs 35 and 36. In the illustrated embodiment, the moveable legs 45 and 46 abut the rear abutment surface 35a and 36a of the stationary legs 35 and 36 so that an outer surface of the shelves 50a, 50b, and 50c is flush with an outer edge of the projecting side surface 35b and 36b. In this manner, the storage apparatus 30 assumes a low-profile configuration of 1.5 inches when not in use, that is, in the stowed configuration, thereby consuming a minimal amount of space within the storage unit 10.

Each tab 62a, 62b, 62c of each inner hinge assembly 60a, 60b, and 60c extends a length from the rear abutment surface 35a and 36a to position the each of the apertures, such as aperture 73, that are sized and shaped to receive the bolts, such as bolt 75, and ultimately the shelves 50a, 50b, and 50c, a corresponding length from the rear abutment surfaces 35a and 36, e.g., such as ½ inch. In this manner, the shelves 50a, 50b, and 50c are capable of moving past a center of gravity when rotating from the use configuration to the stowed configuration. In other words, as the shelves 50a, 50b, and 50c are perfectly vertical, the length provided by the positioning of the shelves 50a, 50b, and 50c on each tab 62a, 62b, 62c permits the shelves 50a, 50b, and 50c to move past perfectly vertical and to abut rear abutment surface 35a and 36a. In this manner, the shelves 50a, 50b, and 50c utilize gravity in the stowed configuration to maintain the stowed configuration without the aid of any fastener. It is foreseen that any one or more of the shelves 50a, 50b, and 50c may be positioned on a corresponding tab 62a, 62b, 62c to provide such an over-center of gravity function.

To facilitate movement of the storage apparatus 30 to and from the use configuration and the stowed configuration, handles 80 are provided on each of the moveable legs 45 and 46, and handles 81 are provided on middle shelf 50b. The handles 80 extend horizontally from the moveable legs 45 and 46 when the storage apparatus 30 is in the use configuration and the stowed configuration, as illustrated by FIGS. 3 and 8. The handles 81 extend vertically downward from the middle shelf 50b when the storage apparatus 30 is in the use configuration and extend horizontally from the middle shelf 50b when the storage apparatus 30 is in the stowed configuration, as illustrated by FIGS. 3 and 8. Thus, when the storage apparatus 30 is in the use configuration, the handles 81 are substantially concealed by the middle shelf 50b.

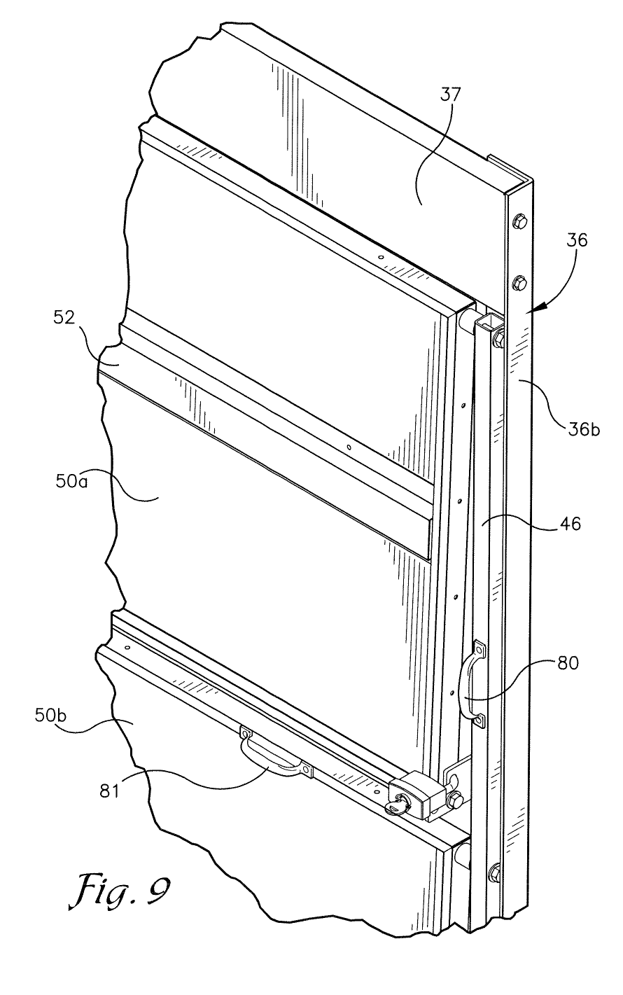

The apparatus is also preferably provided with a lock mechanism designed to at least selectively lock the apparatus in the stowed configuration and, more preferably in both the use and stowed configurations. Tab 62a of hinge assembly 60a includes at least two locking apertures 90 and 9l to receive a lock, such as padlock 100, therethrough. The locking apertures 90 and 91 are provided in addition to the hinge assembly 60a aperture previously discussed. When the storage apparatus 30 is in the use configuration, the locking aperture 90 aligns with an aperture (not illustrated) in shelf 50a to enable insertion of the padlock 100 therethrough, as illustrated in FIG. 7. When the storage apparatus 30 is in the stowed configuration, the locking aperture 91 aligns with the aperture (not illustrated) in the shelf 50a to enable insertion of the padlock 100 therethough. In this manner, the storage apparatus 30 may be locked in either the use configuration or the stowed configuration, as illustrated in FIG. 9.

It is foreseen that, in addition to or instead of the locking apertures 90 and 91, a locking assembly (not illustrated) including a hinged latch that shiftable to and from a latched position may be used. The locking assembly may depend from the storage apparatus 30 in a position such that when the storage apparatus 30 is in the stowed configuration, the latch may be shifted to abut at least one of the shelves 50a, 50b, and 50c and/or moveable legs 35 and 36 to secure the storage apparatus 30 in the stowed configuration. The latch may have an aperture that aligns with another aperture on at least one of the shelves 50a, 50b, and 50c and/or moveable legs 35 and 36 to lock the latch in the latched position and the storage apparatus 30 in the stowed configuration.

In use, the storage unit 10 provides an ability to generate additional revenue for a storage facility using the present inventive concept. In the illustrated embodiment, if a user of the storage unit 10 desires use of the storage apparatus 30 and compensates the operator of the storage facility for such use in addition to general use of the storage unit 10, the operator may unlock the storage apparatus 30 to enable use of the storage apparatus 30 by the user. Alternatively, if the user of the storage unit 10 does not compensate the operator of the storage unit 10 for use of the storage apparatus 30, the operator may lock the storage apparatus 30 in the stowed configuration to prevent use of the storage apparatus 30 by the user. The apparatus 30 may also be locked in the use configuration, if desired.

The preferred forms of the present inventive concept described above are to be used as illustration only, and should not be utilized in a limiting sense in interpreting the scope of the present inventive concept. Obvious modifications to the preferred embodiments, as hereinabove set forth, could be readily made by those skilled in the art without departing from the spirit of the present inventive concept.

The inventors hereby state their intent to rely on the Doctrine of Equivalents to determine and assess the reasonably fair scope of the present inventive concept as pertains to any apparatus not materially departing from but outside the literal scope of the present inventive concept as set forth in the following claims.

1. A fold-up storage rack comprising:
stationary support structure;
shelving having a first hinged connection with said stationary support structure for selective placement of the shelving in either a deployed position in which the shelving is folded-down and extends generally horizontally outwardly away from the stationary support structure or a stowed position in which the shelving is folded-up and extends generally vertically upwardly adjacent the stationary support structure; and
movable support structure having a second hinged connection with said shelving at a location spaced outwardly from said first hinged connection for engaging a supporting surface below the shelving when the shelving is in said deployed position and supporting the shelving above such surface,
said movable support structure being disposed to pivot relative to the shelving as the shelving is raised into the stowed position whereby to be disposed adjacent said stationary support structure when the shelving is in the stowed position.

2. The fold-up storage rack as claimed in claim 1,
said shelving comprising a plurality of vertically spaced shelves.

3. The fold-up storage rack as claimed in claim 2,
each of said shelves having an inboard end nearest said stationary support structure that is pivotally connected to said stationary support structure and an outboard end most remote from the stationary support structure that is pivotally connected to said movable support structure.

4. The fold-up storage rack as claimed in claim 3,
said support structures and said shelves cooperatively forming a parallel linkage.

5. The fold-up storage rack as claimed in claim 1,
said stationary support structure comprising a first pair of laterally spaced, upright legs,
said movable support structure comprising a second pair of laterally spaced, upright legs.

6. The fold-up storage rack as claimed in claim 5; and
a transverse member rigidly interconnecting upper ends of said first legs.

7. The fold-up storage rack as claimed in claim 1,
said stationary structure and said shelving being configured to permit said shelving to be at least partially nested within said stationary structure when the shelving is in said stowed position whereby to reduce the profile of the rack.

8. The fold-up storage rack as claimed in claim 7,
said stationary structure having a width dimension that is greater than the corresponding width dimension of said shelving.

9. The fold-up storage rack as claimed in claim 8,
said stationary structure comprising a pair of upright, laterally spaced legs,
each of said legs being generally L-shaped in transverse cross-section to present a rear web and side web projecting forwardly from the rear web,
said legs being oriented such that the rear webs of the legs extend generally toward one another at the rear of the rack and the side webs extend generally parallel to one another at the sides of the rack to provide clearance for the shelving to nest between the side webs in the stowed position.

10. The fold-up storage rack as claimed in claim 1; and
a lock for selectively locking the shelving in the stowed position.

11. The fold-up storage rack as claimed in claim 10,
said lock including lock plate fixed to the stationary support structure, with at least one of said shelving and moveable support structure being releasably secured to the lock plate when the shelving is locked in the stowed position.

12. The fold-up storage rack as claimed in claim 11,
said lock plate and said at least one of the shelving and moveable support structure presenting respective apertures that are aligned when the shelving is in the stowed position;
said lock including a padlock removably received in part in the aligned apertures so as to releasably secure the shelving in the stowed position.

13. The fold-up storage rack as claimed in claim 12,
said lock plate including a second aperture that is aligned with the aperture in said at least one of the shelving and moveable support structure when the shelving is in the deployed position, such that shelving is also selectively lockable in the deployed position.

14. The fold-up storage rack as claimed in claim 1; and
feet at a lower end of said stationary structure and fasteners for securing said feet to the supporting surface and providing structural support to the fold-up storage rack,
said feet and said fasteners being the only structural support for the fold-up storage rack.

15. A selectively reconfigurable storage unit comprising:
an enclosure having a floor and a plurality of walls projecting upwardly from said floor to cooperatively define a confined storage space within which a person can move,
said enclosure further having an access door permitting access to said storage space from outside the enclosure when the door is open; and
at least one fold-up storage rack within said storage space adjacent a wall of the enclosure for supporting articles off the floor of the enclosure,
said storage rack being selectively shiftable between a deployed position in which shelving of the rack projects generally horizontally outwardly away from the wall to occupy a portion of the storage space and a stowed position in which the shelving is collapsed generally flatly against the wall to avoid occupying said portion of the storage space.

16. The reconfigurable storage unit as claimed in claim 15,
said rack being attached to said wall.

17. The reconfigurable storage unit as claimed in claim 15,
said rack being free-standing, supported by only the floor of the enclosure such that said rack is devoid of any other support element.

18. The reconfigurable storage unit as claimed in claim 15; and
a lock for selectively locking the rack in the stowed position.

19. The reconfigurable storage unit as claimed in claim 18,
said lock including lock plate fixed to the stationary support structure, with at least one of said shelving and moveable support structure being releasably secured to the lock plate when the shelving is locked in the stowed position.

20. The fold-up storage rack as claimed in claim 19,
said lock plate and said at least one of the shelving and moveable support structure presenting respective apertures that are aligned when the shelving is in the stowed position;
said lock including a padlock removably received in part in the aligned apertures so as to releasably secure the shelving in the stowed position.

21. The fold-up storage rack as claimed in claim 20,
said lock plate including a second aperture that is aligned with the aperture in said at least one of the shelving and moveable support structure when the shelving is in the deployed position, such that shelving is also selectively lockable in the deployed position.

22. The reconfigurable storage unit as claimed in claim 15,
said rack including stationary upright support structure adjacent the wall and movable upright support structure spaced outwardly from said stationary upright support structure,
said shelving extending between said stationary and movable support structures and hingedly interconnecting said structures.

23. The reconfigurable storage unit as claimed in claim 22,
said shelving comprising a plurality of vertically spaced shelves.

24. The reconfigurable storage unit as claimed in claim 22,
each of said shelves having an inboard end nearest the wall that is pivotally connected to said stationary support structure and an outboard end most remote from the wall that is pivotally connected to said movable support structure.

25. The reconfigurable storage unit as claimed in claim 24,
said support structures and said shelves cooperatively forming a parallel linkage.

26. The reconfigurable storage unit as claimed in claim 25,
said stationary support structure comprising a framework having a pair of laterally spaced, rear legs and a transverse member rigidly interconnecting upper ends of the rear legs,
said movable support structure comprising a pair of laterally spaced, front legs attached to the shelving at locations disposed forwardly from the rear legs.

27. The reconfigurable storage unit as claimed in claim 22,
said stationary support structure and said shelving being configured to permit said shelving to be at least partially nested within said stationary support structure when the shelving is in said stowed position whereby to reduce the profile of the rack.

28. The reconfigurable storage unit as claimed in claim 27,
said stationary support structure having a width dimension that is greater than the corresponding width dimension of said shelving.

29. The reconfigurable storage unit as claimed in claim 28,
said stationary support structure comprising a pair of upright, laterally spaced legs,
each of said legs being generally L-shaped in transverse cross-section to present a rear web and side web projecting forwardly from the rear web,
said legs being oriented such that the rear webs of the legs extend generally toward one another at the rear of the rack and the side webs extend generally parallel to one another at the sides of the rack to provide clearance for the shelving to nest between the side webs in the stowed position.

30. A method for renting a storage unit, the method comprising the steps of:
providing a storage unit operable to secure items to be stored therein;
providing at least one storage apparatus secured within the storage unit, the storage apparatus having a use configuration and a non-use configuration;
locking the storage apparatus in the non-use configuration to prevent conversion of the storage apparatus from the non-use configuration to the use configuration;
offering to rent the storage unit for a first amount;
offering to rent the storage apparatus for a second amount; and
unlocking the storage apparatus to permit conversion of the storage apparatus from the non-use configuration to the use configuration if the first amount and the second amount are received by an operator of the storage unit.

31. The method according to claim 30,
the storage apparatus including at least one shelf operable to receive at least one or more of the items to be stored thereon when the storage apparatus is in the use configuration.

32. The method according to claim 31,
the at least one shelf being in a vertical orientation when the storage apparatus is in the non-use configuration, and
the at least one shelf being in a horizontal orientation when the storage apparatus is in the use configuration.

33. The method according to claim 30,
the storage apparatus fastened to an internal wall of the storage unit.

34. The method according to claim 30,
the first amount is a predetermined rental amount for the storage unit defined by the operator of the storage unit, and
the second amount is a predetermined rental amount for the storage apparatus that is different than the first amount and defined by the operator of the storage unit.

35. The fold-up storage rack as claimed in claim 1,
the shelving extending at a convergent angle with respect to the stationary support structure when the shelving is in the stowed position.

36. The reconfigurable storage unit as claimed in claim 15,
the shelving extending at a convergent angle with respect to the wall when the shelving is in the stowed position.

37. The fold-up storage rack as claimed in claim 1, and
a center of gravity defined by the shelving when the shelving extends generally vertical to the stationary support structure, the shelving operable to extend past the center of gravity when the shelving is raised from the deployed position to the stowed position and lowered from the stowed position to the deployed position.

38. The reconfigurable storage unit as claimed in claim 15, and
a center of gravity defined by the shelving when the shelving extends generally vertical to the wall, the shelving operable to extend past the center of gravity when the shelving is raised from the deployed position to the stowed position and lowered from the stowed position to the deployed position.
